(19) United States
(12) Patent Application Publication
(10) Pub. No.: US 2015/0351469 A1
(43) Pub. Date: Dec. 10, 2015

(54) GARMENT AND COVER COMBINATION TO AID IN USER MOBILITY

(71) Applicant: Nancy MCGOVERN, Kamloops (CA)

(72) Inventor: Nancy McGovern, Kamloops (CA)

(21) Appl. No.: 14/761,592

(22) PCT Filed: Jan. 15, 2014
(86) PCT No.: PCT/IB2014/058271

§ 371 Date: Jul. 16, 2015

Related U.S. Application Data
(60) Provisional application No. 61/754,557, filed on Jan. 19, 2013.

(51) Int. Cl. A41D 13/12; B32B 5/26; B32B 5/02; A41D 31/00; D04B 1/12

(52) U.S. Cl. CPC A41D 13/1254; A41D 31/0016; D04B 1/12; B32B 5/024; B32B 5/026; B32B 5/26; B32B 5/028; B32B 2307/746; B32B 2437/00; B32B 2307/51; B32B 2262/0276

(57) ABSTRACT

A combination of a machine knit first layer and a weave fabric second layer for reducing friction between the layers is provided. The machine knit first layer comprises an upper surface with a first vector and a lower surface with a second vector or it comprises an asperities vector and the weave fabric second layer has an upper surface having a long vector or an asperities vector and a short vector, and a lower surface. The upper or lower surface of the first layer is for contact with the upper surface of the second layer, and the orientation of the first or second vectors or the asperities vector relative to the long vector or asperities vector control the friction between the first and second layer, such that in use, the layers are oriented such that friction is reduced between the layers or friction is selectively reduced for only one of lateral or longitudinal movement.

### BACKGROUND OF THE INVENTION

1. Field of the Invention

The present technology relates to the use of specific combinations of fabrics to reduce friction between a user and a surface, such as a bed, a chair, or a car seat. More specifically, the technology relates to garments made from a stretchable machine knit fabric in combination with a cover made from a weave fabric or vice versa.

2. Description of the Related Art

As the population ages, we are faced with a rising number of people living at home who have need of physical care. Health care support systems are increasingly being developed to enable aging at home thereby hoping to avoid admission to residential care facilities that are few in number compared to the projected needs. While most people consider losing the ability to walk freely and safely about a house a major reason for someone to have to leave their house and move to a care facility, there are far more insidious mobility issues that plague a high number of aged people. One of the most significant of these is being able to move on a surface, such as a chair, a bed, a car seat and the like. Equally as significant, is an inability to don and doff clothing easily. Of course, these concerns are equally as significant for younger people who have mobility issues. It is also thought that improving mobility while at rest can improve a night's sleep for many people.

There is prior art that addresses the issue of reducing friction between a person and a surface. Most of this prior art is directed to reducing bedsores and related maladies in the bedridden, or assisting caregivers in moving supine patients. For example, US Publication No. 20110167532 discloses a two-ply fabric low friction interface made of two layers of tricot fabric. Each layer has a shiny side and the shiny sides of the two layers of fabric face each other. Each layer of fabric has a machine direction M, and the layers of fabric are positioned such that the machine direction M of one layer is perpendicular to the other layer. A garment includes a low friction zone and a higher friction zone adjacent the low friction zone, the higher friction zone comprising a material different from a material of the low friction zone. The low friction zone comprises two layers of fabric with their shiny sides, facing each other and their machine directions M oriented perpendicularly. Also described is a method of preventing or treating a skin wound comprising clothing a living being in a garment.

Another example is in U.S. Pat. No. 5,123,113 where a selective body portion protecting means for use on an elbow, knee, leg, calf, or the like, to prevent friction on a wound, burn, bed sore, or the like is disclosed. The protector includes a first non-woven fabric which contacts the body portion, and a second frictionless fabric which contacts the first non-woven fabric, and a third frictionless fabric which contacts the second frictionless fabric and which rests on a support. The first and second fabrics typically are formed and joined so as to envelop the selective body portion.

Another application of technologies that reduce friction between fabrics is in moving patients. In U.S. Pat. No. 4,944,053 a fabric device useful in facilitating the movement of a person's body while lying on a bed, resting surface, examining table or the like is disclosed. The fabric device comprises a first fabric made from a non-woven material similar to HANDI-WIPE® material. This first fabric is secured to an identically sized and shaped second fabric of relatively frictionless material such as woven, synthetic material or even a plastic sheet.

Another example is in U.S. Pat. No. 6,349,432 in which a method and apparatus for patient transfer is disclosed in which unidentified low friction materials are used to assist in moving or transferring a supine person or other body between two platforms, permitting a single caregiver of less than average strength to perform such transfer between an unmodified bed and a second surface, which may for example be part of a transport device.

In U.S. Pat. No. 7,281,549 and US Publication No. 20080121305, a low friction fabric is disclosed that is constructed of a first layer of woven polyester fibers with an upper and lower woven surface attached to and adjacent a second layer of the same weave of polyester fibers, the second layer having an upper and lower surface. The fabric has a satin weave (over four and under one). Each of the woven layers comprising a straight yarn in the warp of the weave pattern with the weaves of the layers being oriented at a 90 degree angle to one another. This fabric is contemplated for use in socks, bandages, a shoe insert, sheet, pillowcase and other bed linen.

A combination is needed that includes: clothing that is easy to don and doff, especially for people with reduced mobility or flexibility, and that is comfortable; and a fabric surface that when used with the clothing provides low friction movement in at least one direction and high friction movement in at least one other direction

### SUMMARY OF THE INVENTION

The present technology provides combinations that allow for low friction movement in one or more directions—back and forth laterally, or up and down, longitudinally and preferably, high friction in at least one other direction. Advantageously, by selecting fabric combinations, one can obtain comfortable, easy to don and doff clothing that when in combination with the appropriately selected fabric provides:

1. Good lateral movement back and forth, with high friction longitudinally, and therefore limited movement longitudinally;
2. Good longitudinal movement up and down, with high friction laterally, and therefore limited movement laterally;
3. Good longitudinal movement in only one direction—preferably upward, with low friction laterally;
4. Low friction in all directions in one or more orientations, with taffeta providing low friction in all directions in all orientations with most fabrics tested; and
5. A combination of low friction in all directions and either good lateral movement back and forth with high friction longitudinally or good longitudinal movement in only one direction.

Specifically, the present technology provides low friction combination comprising a garment and a layer of a weave fabric, the garment comprising a machine knit fabric having a surface with a first vector or an asperities vector, the weave fabric comprising a surface having a long vector and a short vector, or an asperities vector, wherein at least a portion of the surface of the machine knit fabric is configured for contact with the surface of the weave fabric at a vector angle of about 45 degrees to about 135 degrees to reduce friction between the garment and the weave fabric.

Preferably, the vector angle is about 90 degrees.

The garment is preferably selected from the group consisting of a nightgown, hospital gown, underwear, pants, pajamas, shirt, dress, shorts, boxers, a skirt, socks, sports clothing, sleeves, linings, and leggings for under athletic padding and guards, braces and supports.

4. The combination of claim 3, wherein the machine knit fabric is a jersey knit, a pique, a tricot, an interlock knit or a micromesh, each comprising one or more of silk, polyester or nylon.

Advantageously, the machine knit fabric is a jersey knit, a pique, a tricot, an interlock knit or a micromesh, each comprising one or more of silk, polyester or nylon.

The machine knits may be with or without elastane.

The weave fabric may be a satin weave, with or without elastane.

Preferably the weave fabric is a sheet or a panel in a sheet.

Most preferably the machine knit fabric is a polyester interlock knit.

Preferably, a portion of the machine knit fabric of the garment is aligned to reduce friction between the garment and the weave fabric and a remainder of the garment is aligned to increase friction between the garment and the sheet.

Alternatively, a portion of the sheet is aligned to reduce friction between the garment and the sheet and a remainder of the sheet is aligned to increase friction between the garment and the sheet.

In another embodiment, a combination having directionally selective friction is provided, comprising a garment and a layer of a weave fabric, the garment comprising machine knit fabric having a surface with a first vector or an asperities vector, the weave fabric having a long vector and a short vector or an asperities vector, wherein only a portion of the surface of the weave fabric is aligned for contact with the machine knit fabric at a vector angle of about 0 degrees to about 15 degrees to increase friction between the garment and the weave fabric for only one of lateral or longitudinal movement.

Preferably, the first vector or the asperities vector of the machine knit fabric and the long vector or asperities vector of the weave fabric are parallel in the portion of the surface of the weave fabric.

Advantageously, the fabrics are aligned to reduce friction for lateral movement.

Preferably, the surface of the machine knit fabric has the asperities vector.

Preferably the machine knit fabric is a polyester interlock knit (with or without elastane) and the weave fabric is a 100% polyester.

Preferably the weave fabric is a sheet or a panel in a sheet.

In another embodiment, a combination is provided comprising a first layer that is a machine knit fabric having a surface with a first vector or an asperities vector and a second layer that is a weave fabric having an upper surface having a long vector and a short vector or an asperities vector, wherein the surface of the first layer contacts the upper surface of the second layer, the orientation of the first vector or the asperities vector of the first layer relative to the long vector or asperities vector of the second layer controlling the friction between the first and second layer, such that in use, the layers are oriented such that friction is reduced between the layers or friction is selectively reduced for only one of lateral or longitudinal movement.

Preferably the weave fabric is a garment.

More preferably the garment is selected from the group consisting of a nightgown, hospital gown, underwear, pants, pajamas, shirt, shorts, boxers, a skirt, dress, socks, sports clothing, sleeves and leggings for under athletic padding and guards, braces and supports.

Most preferably there is low friction with lateral movement and high friction with longitudinal movement.

Advantageously, the first vector or the asperities vector of the first layer is parallel to the long or asperities vector of the second layer in a first section of the combination.

Additionally, the first vector or the asperities vector of the first layer is orthogonal to the long or asperities vector of the second layer in a second section of the combination.

In another embodiment an arm tube for assisting in moving a patient on a surface is provided, the sleeve comprising an upper side comprising a first fabric configured to provide a vector angle resulting in low friction between the arm tube and a patient in a suitably selected garment and a lower side comprising a second fabric configured to provide a vector angle resulting in low friction between the arm tube and a suitably selected surface.

Preferably the upper side is a weave fabric, the patient garment is a machine knit fabric, the lower side is a machine knit fabric, the surface is a weave fabric and the vector angles are about 90 degrees.

In another embodiment, a combination comprising a machine knit fabric and a 100% polyester taffeta fabric is provided, the machine knit fabric having an asperities vector, the taffeta fabric having an asperities vector, and the orientation of the asperities vectors defining a vector angle, wherein friction is low between the fabrics at all vector angles.

In another embodiment a combination comprising a three over and one under or four over and one under weave fabric and a machine knit fabric is provided, the weave fabric having a long vector, the machine knit fabric having a first vector and a second vector, wherein orthogonal or parallel orientation of the long vector relative to the first and second vector results in low friction associated with movement in all directions for one orientation, and high friction associated with movement in either the lateral or longitudinal direction, but not both, for the other orientation.

In yet another embodiment a machine knit fabric having more than one first vector, second vector or asperities vector on a given surface is provided, the more than one vectors resulting in different friction zones within the fabric.

In yet another embodiment a weave fabric having more than one long vector or asperities vector on a given surface is provided, the more than one vectors resulting in different friction zones within the fabric.

In yet another embodiment, a combination comprising a silk plain weave fabric or a satin weave fabric and a silk machine knit fabric is provided, the plain weave fabric having an asperities vector, the satin weave fabric having a long vector and the machine knit fabric having a first vector, wherein orthogonal orientation of the vectors results in low friction associated with movement in all directions and parallel orientation of the vectors results in high friction associated with movement in either the lateral or longitudinal direction.

### BRIEF DESCRIPTION OF THE DRAWINGS

FIG. 1 is the combination of the present technology.

FIG. 2 shows the details of the weave of the combination of FIG. 1.

FIG. 3 shows the asperities vector of the present technology.

FIG. 5 shows the arm tube.

### DESCRIPTIONS OF THE PREFERRED EMBODIMENTS

### Definitions

### Satin Fabric:

A satin fabric is a fabric with a three over one or a four over one weave. It can be made of a range of fibres, including but not limited to cotton, silk and synthetics.

### Weft Knit:

A weft knit is made with a single yarn that's looped to create horizontal rows, or courses, with each row built on the previous row. All weft knits fall into three basic categories: rib knits, which are a combination of knit and purl stitches; purl knits, which are made with purl stitches alone, and jersey knits, which are made with knit stitches on the front and purl stitches on the reverse. Only machine knit fabrics are included in the present technology.

### Warp Knit:

A warp knit is made with multiple parallel yarns that are simultaneously looped vertically to form the fabric. Both warp and weft knits can be made either on a circular knitting machine, which produces a tube of fabric, or on a flat-bed knitting machine, which delivers flat yardage.

### Tricot:

Face has fine lengthwise ribs; reverse has crosswise ribs. Some machines can produce complex patterns, and some can incorporate a weft insertion (extra yarn inserted crosswise) for added texture or color. [symbol] Tricot has some lengthwise stretch or crosswise stretch.

### Interlock Fabric:

Compound fabric made by “inter-knitting,” or interlocking, two simple ribbed fabrics, each made with single yarn. Generally has fine ribs running lengthwise. Fabric's face and reverse look same, making it reversible.

[symbol]

### Interlock Knit:

A fabric that has two plies knit simultaneously to form one thicker and heavier ply. It has more natural stretch than a jersey knit, and the same appearance and feel on both sides. It has an asperities vector.

### Jersey Knit:

Also referred to as plain knit or single knit. Has distinct right and wrong sides, with fine ribs running lengthwise on fabric's face (outside), and semicircular loops running across reverse. The outer surface is smoother than the inner surface. Many variations of stitches and fibers create wide variety of single knits, ranging from delicate openwork to heavy, thick piled fabric. It has little or no lengthwise stretch, varying amounts of crosswise stretch.

Pique Knit: A single knit construction also known as honeycomb or mesh.

### Taffeta:

Taffeta is a plain weave fabric (over one under one). Two taffetas are used in testing—one with carbon fibre thread arranged longitudinally, the other is without the carbon fibre thread.

### Micromesh:

Micromesh is a knit.

### Microfiber Fabric:

Microfibre fabrics are plain weave and have significantly more tendrils of yarn per strand than do most other fabrics. For example, other fabrics may have 70-80 tendrils of yarn per strand whereas microfibre may have about 216 tendrils per strand.

### Long Vector:

A vector aligned with the length of the “over” yarn in a satin or satin-type weave. In other words, the direction of the “four” in an under one and over four weave, and the “three” in an under one and over three weave. The long vector is also the vector aligned with the length of ribbing in knits. The long vector is used when there are macroscopic differences in the weave or the knit.

### Asperities Vector:

A vector aligned with the direction of movement of a plain weave fabric or a knit fabric giving the lowest friction. The asperities vector is used when there are no macroscopic differences in the weave or knit but are microscopic differences in the weave or knit.

### Four Directions of Movement:

In the context of the present technology, four directions of movement is indicative of movement in all directions.

### Two Directions of Movement:

In the context of the present technology, two directions of movement is indicative of good lateral movement with poor longitudinal movement, or poor lateral movement with good longitudinal movement. Alternatively, this can be defined as high friction when the fabrics are moved laterally, and low friction when the fabrics are moved longitudinally, or the converse.

### Orthogonal:

In the context of the present technology, orthogonal refers to about a ninety degree angle between the vectors.

### Parallel:

In the context of the present technology, parallel refers to about a zero degree angle between the vectors.

### Vectors:

In the context of the present technology, all vectors are bidirectional vectors.

### Surface Coated:

In the context of the present technology, surface coated refers to one of two types of coatings. One is a topical treatment where chemicals are placed onto the knit fabric after it's knit—via a bath. The chemical eventually washes out. The second way is bathing the yarn before it's knit. This does not wash out and is environmentally friendly. This is not expected to affect friction.

Laterally and longitudinally are used as relative terms and do not indicate movement across the machine direction or along the machine direction necessarily, but may.

### DESCRIPTION

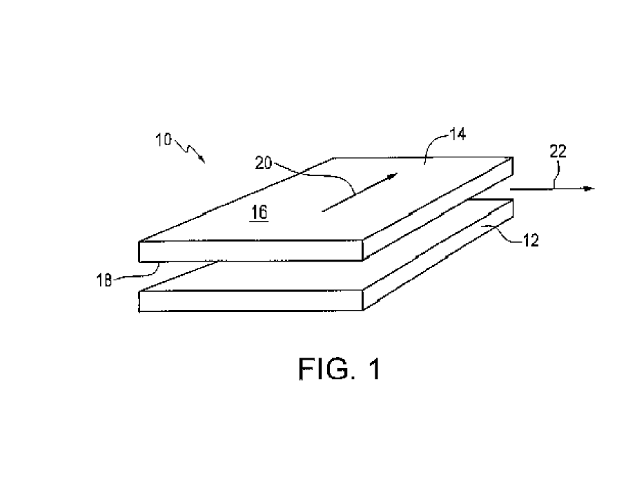

A combination, generally referred to as 10 is shown in FIG. 1. A weave fabric 12 interacts with a machine knit fabric 14. The knit fabric 14 has a first surface 16 and a second surface 18, as shown in FIG. 1. Most knit fabrics have ribbing or other discernible sculpturing on the first surface 16 and ribbing or other discernible sculpturing on the second surface 18. The ribbing on the two surfaces are generally orthogonal to one another. The direction of the ribbing on the first surface 16 is referred to as the first vector 20 and the direction of the ribbing on the second surface 18 is referred to as the second vector 22. Movement along the direction of ribbing is associated with a lower coefficient of friction.

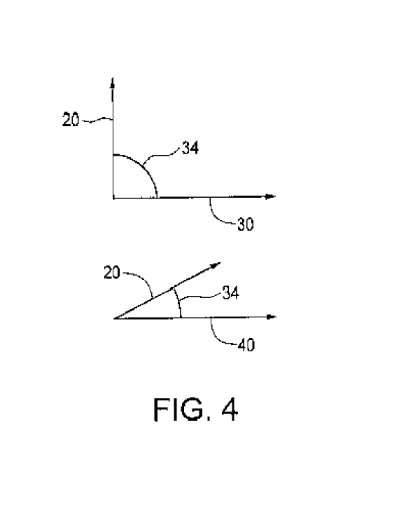

Through experimentation, it was found that interlock knits, which do not have ribbing or any apparent directionality and therefore do not have first or second vectors, have asperities vectors. An asperities vector 40 (as shown in FIG. 3) results in microscopic interactions between layers of fabric. Without being bound to theory, this may result from use of differing yarns, differing type of fibre, type of blend, blend proportion, yarn structure, fabric structure, crimp and crimp height, compressibility, and tension.

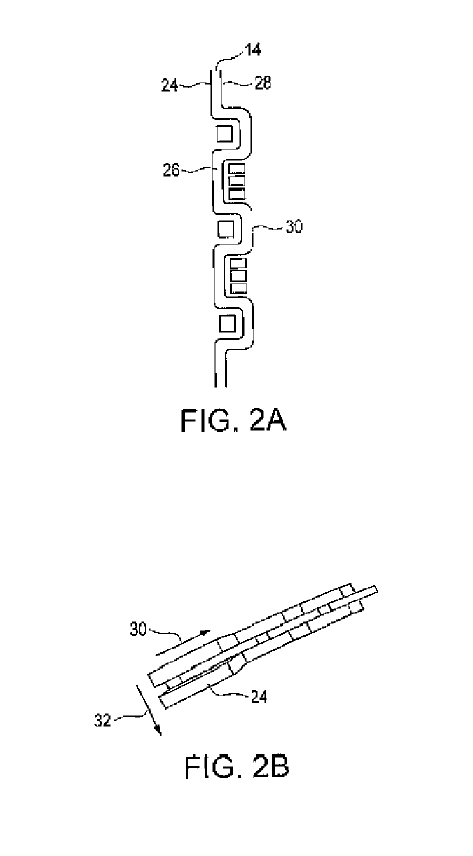

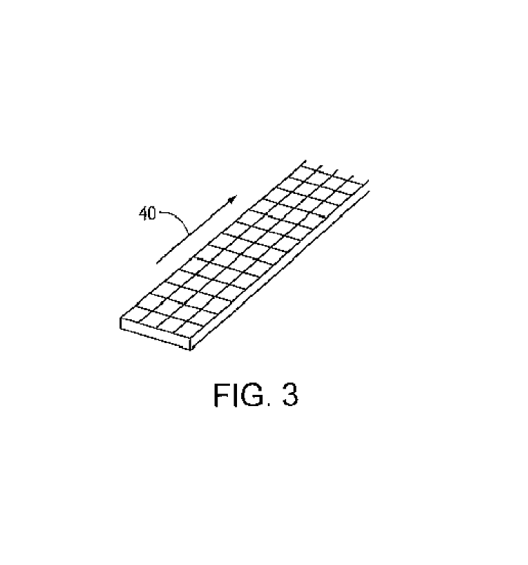

As shown in FIG. 2, the weave fabric 14 preferably has an under one and over four weave (referred to as a satin weave), but may have an under one and over three weave, the latter providing for a fabric that is more durable and less prone to pulls, while still offering sufficient length of warp over weft, or weft over warp to allow for a low coefficient of friction. Whether weft over warp or warp over weft, the first weave surface 24 has the over three 26 and is therefore a more even surface and the second weave surface 28 has the under one 30 and is therefore a more sculpted surface. The direction of the fabric on the first weave surface 24 is defined by the over three 26 and is referred to as the long vector 30 and the direction of the fabric orthogonal to the long vector 30 is the short vector 32. The long vector 30 is therefore the direction that provides a lower coefficient of friction.

As shown in FIG. 3, unbalanced plain weave fabrics are defined as having an asperities vector 40 rather than a long vector 30. The long vector 30 results in macroscopic interactions between layers of fabric, whereas the asperities vector 40 results in microscopic interactions between layers of fabric. The unbalanced plain weave may result from use of differing yarns, differing type of fibre, type of blend, blend proportion, yarn structure, fabric structure, crimp and crimp height, compressibility, and tension.

As shown in FIG. 4, depending on the desired outcome and the fabrics used, the machine knit fabric 14 and the weave fabric 12 are combined to provide various vector angles 34. In general, a low coefficient of friction in all directions can be obtained when the machine knit fabric 14 and the weave fabric 12 are used in combination such that one of the first vector 20 and second vector 22 are orthogonal to the long vector 30 or asperities vector 40, however, this is not always the case as can be seen from the table below. Suitable vector angles 34 can be about 45 to about 135 degrees, preferably about 60 to about 120 degrees, still more preferably about 80 to about 100 degrees, and most preferably about 90 degrees.

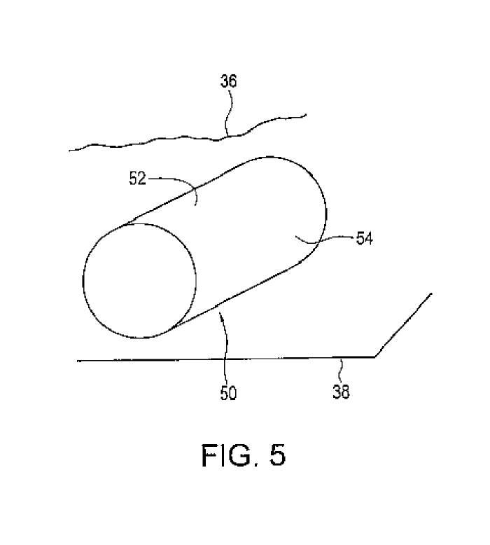

As shown in FIG. 5, the fabrics can be combined as a machine knit fabric garment 36 and a weave fabric surface 38, wherein the weave fabric surface 38 may be a sheet, a car seat cover, a chair cover, a boot lining, a shoe lining, an exercise mat cover, transfer board cover, athletic padding and guards, lining for braces and supports, and the like. The machine knit fabric garment 36 may be pajamas, a nightdress, shirt, shorts, boxers, pants, a skirt, socks, sports clothing, sleeves and leggings for under athletic padding and guards, braces and supports and the like. The advantages of this combination are that the garments are easy to don and doff, which is a significant advantage to the elderly, injured or infirm, they provide some flexibility and stretch, they are frequently breathable, they are frequently wicking, and they are frequently antimicrobial.

Alternatively, the fabrics can be combined in a machine knit fabric surface and a weave fabric garment, wherein the machine knit fabric surface may be a sheet, a car seat cover, a chair cover, a boot lining, a shoe lining, an exercise mat cover, transfer board cover, athletic padding and guards, lining for braces and supports, and the like. The weave fabric garment may be pajamas, a nightdress, shirt, shorts, boxers, pants, a skirt, a dress, socks, sports clothing, sleeves and leggings for under athletic padding and guards, braces and supports and the like. The advantages of this combination are that the machine knit fabric surface can provide some flexibility and stretch, they are frequently breathable, they are frequently wicking, and they are frequently antimicrobial. The weave fabric may include elastane. This makes the garment easier to don and doff as it increases the flexibility and stretch of the fabric.

While the prior art has shown that a satin weave on satin weave or a tricot on tricot can result in lower coefficients of friction when the fabrics are aligned orthogonally, it would not be expected that a combination of a weave and a knit could also be oriented either parallel or orthogonally to produce low friction between these two very different fabric types. This finding allows us to exploit the advantages of each fabric as clothing or a covering, while providing combinations resulting in low friction. Another finding was that any orientation of taffeta provided low friction in all directions when used with almost any of the knit fabrics tested.

Advantageously, different coefficients of friction can be obtained. In other words, using specific combinations allows for a low coefficient of friction in two directions, for example, laterally (back and forth), and a higher coefficient of friction in the other two directions, for example, longitudinally (back and forth). Further, a low coefficient of friction can be had in one direction, for example, laterally forward, but not laterally back, nor longitudinally back or forward. This allows for very selective control of movement.

These are supported by the following examples.

### Example 1

Coefficients of friction are determined using a weighted disc and a slider board. The weave fabric covers one of the disc or the slider board, and the machine knit fabric covers the other. The slider board is held at a set angle and the time for the weighted disc to travel the length of the slider board is determined. Low friction is recorded for fast travel times, and a high friction is recorded for a slow travel time. Four directions of travel were measured, and the results recorded. Low friction in all four directions indicated that the two fabrics had a low friction interface for all directions of movement. In examples 2 through 7, the weave fabrics were a Satin [83%/17% polyester/cotton], over four, under one weave, two types of 100% polyester taffeta unbalanced plain weave, one with carbon fibre thread and the other without carbon fibre thread, Durable Water Repellent (DWR) coated 100% polyester unbalanced plain weave microfiber and 100% polyester unbalanced plain weave microfibre.

### Example 2

The weave fabrics were a Satin [83%/17% polyester/cotton], 100% polyester taffeta with carbon fibre thread, 100% polyester taffeta, DWR coated 100% polyester microfiber and 100% polyester microfibre. The knit fabric tested was 87%/13% polyester/Spandex® [elastane] [an elastic fibre], using the method of Example 1 (see Table 1). This fabric is a jersey warp knit. Regardless of whether the first surface or the second surface of the 87%/13% polyester spandex knit fabric was used against the first weave surface of the weave fabric, low friction in four directions was obtained when the first or second vectors were orthogonal to the long vector for Satin and the asperities vector for 100% polyester with carbon fibre. When the vector angle was reduced to zero, in other words, when the first or second vectors were parallel to the long vector or asperities vector, low friction was found along the long vector and high friction was found along the short vector. This provides the potential to allow two directional movement or slide, while inhibiting four (all) directional slide. Hence, for example, if a user is in an inclined bed, the orientation of the fabrics would be such that lateral movement was made easy, while longitudinal movement was inhibited, hence reducing or ameliorating the problem of the user sliding out of position, and ending up slumped at the foot of the bed. Unfortunately, it is the wrong side of the knit that provides better lateral movement. The DWR coated 100% polyester microfibre fabric provided low friction in two directions when the first or second vectors were orthogonal or parallel to the asperities vector, and high friction in the other two directions. Thus, this fabric combination would be suitable for situations where either a longitudinal movement was desirable, and a lateral movement was not, or a lateral movement was desirable, and a longitudinal movement was not. The 100% microfibre polyester provided medium low friction in two directions when either the first or second vectors were orthogonal to the asperities vector and provided very high friction when these vectors were parallel to the asperities vector. Hence, this fabric could be useful when lateral movement with a medium low level of reduced friction is desirable.

TABLE 1
87%/13% polyester/spandex jersey knit and weave fabrics. The number
represents the number of directions of slide, wherein 4L is indicative
of all directions and 2L is indicative of a directional selectivity
(either lateral or longitudinal), and the letter represents the friction,
with L being low friction, ML being medium low friction, M being
medium friction and H being high friction.

| | 1^{st} vector | 1^{st} vector | 2^{nd} vector | 2^{nd} vector |
|---|---|---|---|---|
| Relative to | orthogonal | parallel | parallel | orthogonal |
| long/asperities | | | | |
| vector | | | | |
| Satin | 4L | 2L-2H | 2L*-2H | 4L |
| 83% polyester | | | | |
| 17% cotton | | | | |
| 100% polyester | 4L | 2L-2H | 2L*-2H | 4L |
| taffeta with | | | | |
| carbon fibre | | | | |
| thread | | | | |
| 100% polyester | 4L | 2L-2ML | 2L*-2M | 4L |
| taffeta | | | | |
| DWR coated | 2L-2H | 2L-2H | 2L*-2H | 2L*-2H |
| 100% polyester | | | | |
| microfibre | | | | |
| 100% Polyester | 2ML-2H | 2ML-2H | 2ML*-2H | 2ML*-2H |
| microfibre | | | | |

*lateral direction has the lower friction

### Example 3

The weave fabrics were a Satin [83%/17% polyester/cotton], 100% polyester taffeta with carbon fibre thread, 100% polyester taffeta (without carbon fibre thread), DWR coated 100% polyester microfiber and 100% polyester microfibre. The knit fabric tested was Tricot [100% Antron® nylon] using the method of Example 1 (see Table 2). This is a machine knit fabric. Regardless of whether the first surface or the second surface of the Tricot knit fabric was used against the first weave surface of the weave fabric, low friction in four directions was obtained when the first or second vectors were orthogonal (i.e. were at about a ninety degree angle) to the long vector for Satin or asperities vector for 100% polyester taffeta with or without carbon fibre thread. When the second vector was parallel to the long vector or asperities vector, low friction was found along the long vector or asperities vector and high friction was found along the short vector. When the first vector was parallel to the long vector or asperities vector, a slightly higher friction was found along the long vector and high friction was found along the short vector. Hence this combination provides less potential for use in situations where either lateral or longitudinal movement was desirable, and the other direction of movement was not. The tricot knit and 100% polyester microfiber produced low friction in two directions and high friction in the other two directions for all vector combinations. As noted, when the second vector was parallel or orthogonal to the asperities vector, friction was low when the fabric was moved laterally and was high when it was moved longitudinally. This is especially desirable.

TABLE 2
Tricot knit and weave fabrics. The number represents the number of
directions of slide, wherein 4L is indicative of low friction in
all directions, and the letter represents the friction, with L being
low friction, ML being medium low friction, M being medium friction,
MH being medium high friction, and H being high friction.

| | 1^{st} vector | 1^{st} vector | 2^{nd} vector | 2^{nd} vector |
|---|---|---|---|---|
| Relative to | orthogonal | parallel | parallel | orthogonal |
| long/asperities | | | | |
| vector | | | | |
| Satin | 4L | 2M-2H | 2L*-2M | 4L |
| 83% polyester | | | | |
| 17% cotton | | | | |
| 100% polyester | 4L | 2ML-2H | 2L*-2M | 4L |
| taffeta with | | | | |
| carbon fibre | | | | |
| thread | | | | |
| 100% polyester | 4L | 2ML-2M | 2L*-2ML | 4L |
| taffeta | | | | |
| DWR coated | 2L-2H | 2L-2H | 2L*-2ML | 2L*-2ML |
| 100% polyester | | | | |
| microfibre | | | | |
| 100% Polyester | 2L-2H | 2L-2H | 2L*-2H | 2L*-2H |
| microfibre | | | | |

*lateral direction has the lower friction

### Example 4

The weave fabrics were a Satin [83%/17% polyester/cotton], 100% polyester taffeta with carbon fibre thread, 100% polyester taffeta (without carbon fibre thread), DWR coated 100% polyester microfibre and 100% polyester microfibre. The knit fabric tested was 100% polyester micromesh using the method of Example 1 (see Table 3). Low friction in four directions was obtained when the first vector was orthogonal to the long vector or the second vector was parallel to the long vector for Satin and 100% polyester taffeta with carbon fibre thread. When the first vector was parallel or the second vector was orthogonal to the long vector, low friction was found along the long vector and high friction was found along the short vector. This provides the potential to allow two directional movement or slide, while inhibiting four (all) directional slide. Unfortunately, it is the wrong side of the knit that provides better lateral movement.

Similarly, the DWR coated 100% polyester microfibre fabric with the polyester micromesh would be suitable for use when two directions of movement, for example, lateral movement was desirable, and the other direction of movement, for example, longitudinal, was not desirable, as low friction was found along the long vector and high friction was found along the short vector when the first vector was parallel or the second vector was orthogonal to the long vector. The polyester taffeta with carbon fibre and micromesh combination also had one orientation that resulted in good slide-ability in two directions, for example, longitudinal, and high friction in the other two directions, for example lateral.

TABLE 3
Micromesh knit and weave fabrics. The number represents the number
of directions of slide, wherein 4L is indicative of low friction in
all directions, and the letter represents the - friction, with L being
low friction, ML being medium low friction, M being medium friction,
MH being medium high friction, and H being high friction.

| | 1^{st} vector | 1^{st} vector | 2^{nd} vector | 2^{nd} vector |
|---|---|---|---|---|
| Relative to | orthogonal | parallel | orthogonal | parallel |
| long/asperities | | | | |
| vector | | | | |
| Satin | 4L | 2M-2H | 4L | 2M-2H |
| 83% polyester | | | | |
| 17% cotton | | | | |
| 100% polyester | 4L | 2L-2H | 4L | 2L-2H |
| taffeta with | | | | |
| carbon fibre | | | | |
| thread | | | | |
| 100% polyester | 4L | 2L-2ML | 4L | 2L-2ML |
| taffeta | | | | |
| DWR coated | 2L-2MH | 2L-2H | 2L-2MH | 2L-2H |
| 100% polyester | | | | |
| microfibre | | | | |
| 100% Polyester | 2M-2H | 2ML-2H | 2M-2H | 2ML-2H |
| microfibre | | | | |

### Example 5

The weave fabrics were a Satin [83%/17% polyester/cotton], 100% polyester taffeta with carbon fibre thread, 100% polyester taffeta (without carbon fibre thread), DWR coated 100% polyester microfiber and 100% polyester microfibre. The knit fabric tested was 82%/18% polyester spandex using the method of Example 1 (see Table 4). It is a weft knit jersey. Both satin and the 100% polyester with carbon fibre thread provided four directions of movement when either the first or second vectors were orthogonal to the long vector or asperities vector, respectively. The polyester with carbon fibre thread also provided for longitudinal slide with high friction in the opposite direction when the vectors were in the parallel orientation. This weft knit jersey with either DWR coated 100% polyester microfibre or the 100% polyester microfibre fabrics provided for two directions of movement (laterally) with low friction and high friction in the other directions (longitudinally) when the first vector was either parallel or orthogonal to the asperities vector. These combinations are therefore very useful for situations where lateral movement is desirable and longitudinal movement is not.

TABLE 4
82%/18% polyester spandex and weave fabrics. The number represents
the number of directions of slide, wherein 4L is indicative
of low friction in all directions, and the letter represents
the friction, with L being low friction, ML being medium
low friction, M being medium friction, MH being medium high
friction, and H being high friction.

| | 1^{st} vector | 1^{st} vector | 2^{nd} vector | 2^{nd} vector |
|---|---|---|---|---|
| Relative to | orthogonal | parallel | parallel | orthogonal |
| long/asperities | | | | |
| vector | | | | |
| Satin | 4L | 2MH*-2H | 2MH-2H | 4L |
| 83% polyester | | | | |
| 17% cotton | | | | |
| 100% polyester | 4L | 2L*-2H | 2L-2H | 4L |
| taffeta with | | | | |
| carbon fibre | | | | |
| thread | | | | |
| 100% polyester | 4L | 2L*-2ML | 2L-2ML | 4L |
| taffeta | | | | |
| DWR coated | 2L*-2H | 2L*-2H | 2L-2H | 2L-2H |
| 100% polyester | | | | |
| microfibre | | | | |
| 100% Polyester | 2L*-2H | 2L*-2H | 2L-2H | 2L-2H |
| microfibre | | | | |

*lateral direction has the lower friction

### Example 6

The weave fabrics were a Satin [83%/17% polyester/cotton], 100% polyester with carbon fibre thread, 100% polyester taffeta (without carbon fibre thread), DWR coated 100% polyester microfiber and 100% polyester microfibre. The knit fabric tested was 85%/15% nylon spandex using the method of Example 1 (see Table 5). It is a weft knit jersey. Satin and the 100% polyester with carbon fibre thread provided four directions of movement when the first or second vectors were orthogonal to the long vector. The combination of the knit fabric and the 100% polyester without carbon fibre (taffeta) had low friction in all orientations. Both the satin and the 100% microfibre polyester provided for low lateral friction and high longitudinal friction depending on the orientation of the respective vectors, on the right side of the fabric. This is especially useful in situations where lateral movement is desirable and longitudinal movement is not. The DWR coated 100% polyester fabric additionally provided for four directions of movement when the second vector was orthogonal to the asperities vector. The polyester microfibre fabric provided two directions of movement with low friction and two directions of movement with high friction in all fabric orientations. Notably, the taffeta provided for low friction in all orientations.

TABLE 5
85%/15% nylon spandex and weave fabrics. The number represents
the number of directions of slide, wherein 4L is indicative
of low friction in all directions, and the letter represents
the friction, with L being low friction, ML being medium
low friction, M being medium friction, MH being medium
high friction, and H being high friction.

| | 1^{st} vector | 1^{st} vector | 2^{nd} vector | 2^{nd} vector |
|---|---|---|---|---|
| Relative to | orthogonal | parallel | parallel | orthogonal |
| long/asperities | | | | |
| vector | | | | |
| Satin | 4L | 2L*-2H | 2L-2H | 4L |
| 83% polyester | | | | |
| 17% cotton | | | | |
| 100% polyester | 4L | 2L*-2M | 2L-2M | 4L |
| taffeta with | | | | |
| carbon fibre | | | | |
| thread | | | | |
| 100% polyester | 4L | 4L | 4L | 4L |
| taffeta | | | | |
| 100% polyester | 2L*-2ML | 2L*-2MH | 2L-2MH | 2L-2ML |
| microfibre | | | | |
| coated with | | | | |
| DWR | | | | |
| 100% Polyester | 2L*-2H | 2L*-2H | 2L-2H | 2L-2H |
| microfibre | | | | |

*lateral direction has the lower friction

### Example 7

An arm tube for moving patients is provided. The arm tube, generally referred to as 50, shown in FIG. 5, is for use in combination with both a garment and a surface. Note that the tube can be open-ended or can be closed, in other words, like a sleeve with a mitt at the end. A knit fabric garment 36 and a weave fabric surface 38 may be used, or alternatively, a knit fabric surface 40 and a weave fabric garment 42 may be used. In either case, an upper side 52 of the arm tube 50 is configured to provide low friction between a patient in a garment and a lower side 54 of the arm tube 50 is configured to provide low friction on the surface. Hence, if the garment is a machine knit, and the surface is a weave, the upper side 52 of the arm tube 50 will be a weave fabric and the lower side 54 of the arm tube will be a machine knit. The orientation of the first and second vectors relative to the long vector can be determined from the data provided in Tables 2-5 and 6-19 and based on the requirements. For example, for safety, it may be advantageous to have only lateral movement between the arm tube and the garment, to allow a user to slide the arm tube under a patient, without the patient slipping longitudinally. It may be preferable to similarly have only lateral movement between the surface and the lower side of the arm tube, or all directions of movement may be desirable.

### Example 8

For car seats, it is preferable to orient the fabric on the seat to allow for the lowest friction between the seat and the user's garment to be at about 45 degrees to the longitudinal axis of the car. This provides an orientation that allows for improved slide into the car, while not overly inhibiting rotation of the user as they turn to face along the longitudinal axis of the car. As was noted, a combination of fabrics that provided the best four directional slide would be best suited for car seat and garment combinations, for example the 87%/13% polyester/elastane or micromesh with satin or taffetas.

### Example 9

The fabrics can be combined as a knit fabric garment 36 and a weave fabric surface 38, wherein the weave fabric surface 38 may be a sheet, a car seat cover, a chair cover, a boot lining, a shoe lining, an exercise mat cover, transfer board cover, athletic padding and guards, lining for braces and supports, and the like. The knit fabric garment 36 may be pajamas, a hospital gown, a nightdress, shorts, boxers, pants, a skirt, a dress, socks, sports clothing, sleeves and leggings for under athletic padding and guards, braces and supports and the like. Alternatively, the fabrics can be combined in a knit fabric surface and a weave fabric garment, wherein the knit fabric surface may be a sheet, a car seat cover, a chair cover, a boot lining, a shoe lining, an exercise mat cover, transfer board cover, athletic padding and guards, lining for braces and supports, and the like. The weave fabric garment may be pajamas, a nightdress, shirt, shorts, boxers, pants, a skirt, a dress, socks, sports clothing, sleeves and leggings for under athletic padding and guards, braces and supports and the like. Both the selection of the fabrics and the orientation of them in terms of the relationship between the first and second vectors and the long vector can be determined from the above tables. Further, a barrier region may also be provided on either the garment or the surface that is made from the same material, oriented in a direction to inhibit movement, as needed. For example, there may be a region where all way movement is desired surrounded by a region or zone where only two way movement is desired, or no movement is desired. Careful selection of the fabrics can provide these combinations. Alternatively, different materials could be used that inherently have high friction, however, as noted, this would produce a garment that was obviously made of different fabrics.

### Example 10

The knit fabric tested was 100% polyester interlock with wicking and antibacterial treatment. Both satin and the 100% polyester with carbon fibre thread provided four directions of movement with low friction when either the first or second vectors were orthogonal to the long vector or asperities vector, respectively. The satin and 100% polyester microfiber coated with DWR provided for longitudinal slide with low friction and with high friction in the lateral direction when the vectors were in the parallel orientation. Again, the taffeta provided for low friction in all directions, independent of the orientation.

TABLE 6
100% polyester interlock with wicking and antibacterial treatment
and weave fabrics. The number represents the number of directions
of slide, wherein 4L is indicative of low friction in all directions,
and the letter represents the friction, with L being low friction,
ML being medium low friction, M being medium friction, MH being
medium high friction, and H being high.

| | 1^{st} vector | 1^{st} vector | 2^{nd} vector | 2^{nd} vector |
|---|---|---|---|---|
| Relative to | Orthogonal | Parallel | Orthogonal | Parallel |
| long/asperities | | | | |
| vector | | | | |
| Satin | 4L | 2L-2H | 4L | 2L-2H |
| 100% polyester | 4L | 2L-2M | 4L | 2L-2M |
| with carbon | | | | |
| fiber thread | | | | |
| 100% polyester | 4L | 4L | 4L | 4L |
| taffeta | | | | |
| 100% polyester | 2L-2MH | 2L-2H | 2L-2MH | 2L-2H |
| microfiber | | | | |
| coated with | | | | |
| DWR | | | | |
| 100% polyester | 2ML-2H | 2ML-2MH | 2ML-2H | 2ML-2MH |
| microfiber | | | | |

### Example 11

The knit was 100% recycled polyester interlock with wicking and antibacterial treatment. Both satin and the 100% polyester with carbon fibre thread provided four directions of movement when either the first or second vectors were orthogonal to the long vector or asperities vector, respectively. The satin and the 100% polyester with carbon fibre thread also provided for longitudinal slide with low friction and lateral movement with high friction when the vectors were in the parallel orientation. The 100% polyester microfiber coated with DWR also provided for longitudinal slide with low friction and lateral movement with high friction when the vectors were in the parallel orientation. This provides the potential to allow two directional movement or slide while inhibiting four directional slide. Again, the taffeta provided low friction in all directions independent of orientation.

TABLE 7
100% recycled polyester interlock with wicking and antibacterial
treatment and weave fabrics. The number represents the number of
directions of slide, wherein 4L is indicative of low friction in
all directions, and the letter represents the friction, with L being
low friction, ML being medium low friction, M being medium friction,
MH being medium high friction, and H being high friction.

| | 1^{st} vector | 1^{st} vector | 2^{nd} vector | 2^{nd} vector |
|---|---|---|---|---|
| Relative to | Orthogonal | Parallel | Orthogonal | Parallel |
| long/asperities | | | | |
| vector | | | | |
| Satin | 4L | 2L-2H | 4L | 2L-2H |
| 100% polyester | 4L | 2L-2H | 4L | 2L-2H |
| with carbon | | | | |
| fiber thread | | | | |
| 100% polyester | 4L | 4L | 4L | 4L |
| taffeta | | | | |
| 100% polyester | 2L-2MH | 2L-2H | 2L-2MH | 2L-2H |
| microfiber | | | | |
| coated with | | | | |
| DWR | | | | |
| 100% polyester | 2M-2H | 2MH-2H | 2M-2H | 2MH-2H |
| microfiber | | | | |

### Example 12

The knit was 100% polyester mesh with wicking yarn. Both satin and the 100% polyester with carbon fibre thread provided four directions of movement when either the first or second vectors were orthogonal to the long vector or asperities vector, respectively. The satin also provided for longitudinal slide with high friction in the other direction when the vectors were in the parallel orientation. This provides the potential to allow two directional movement or slide. Again, the taffeta provided low friction in all directions independent of orientation.

TABLE 8
100% polyester mesh with wicking yarn and weave fabrics. The
number represents the number of directions of slide, wherein
4L is indicative of low friction in all directions, and the
letter represents the friction, with L being low friction,
ML being medium low friction, M being medium friction, MH
being medium high friction, and H being high friction.

| | 1^{st} vector | 1^{st} vector | 2^{nd} vector | 2^{nd} vector |
|---|---|---|---|---|
| Relative to | Orthogonal | Parallel | Orthogonal | Parallel |
| long/asperities | | | | |
| vector | | | | |
| Satin | 4L | 2L-2H | 4L | 2L-2H |
| 100% polyester | 4L | 2L-2MH | 4L | 2L-2MH |
| taffeta with | | | | |
| carbon fiber | | | | |
| thread | | | | |
| 100% polyester | 4L | 4L | 4L | 4L |
| taffeta | | | | |
| 100% polyester | 2ML-2MH | 2ML-2H | 2ML-2MH | 2ML-2H |
| microfiber | | | | |
| coated with | | | | |
| DWR | | | | |
| 100% polyester | 2ML-2H | 2M-2H | 2ML-2H | 2M-2H |
| microfiber | | | | |

### Example 13

The knit was 47% nylon, 47% polyester, 6% elastane jersey knit with wicking and antibacterial treatment. The satin and the 100% polyester with carbon fibre thread provided four directions of movement when either the first or second vectors were orthogonal to the asperities vector. All except the taffeta provided for lateral slide with low friction and longitudinal movement with high friction when the second vectors were in the parallel orientation relative to the asperities vector. This provides the potential to allow two directional movement or slide (for example, either lateral or longitudinal but not both), while inhibiting four directional slide. Hence, for example, if a user is in an inclined bed, the orientation of the fabrics would be such that lateral movement was made easy, while longitudinal movement was inhibited, hence reducing or ameliorating the problem of the user sliding out of position, and ending up slumped at the foot of the bed. Again, the taffeta provided low friction in all directions independent of orientation.

TABLE 9
47% nylon, 47% polyester, 6% elastane jersey knit with wicking
and antibacterial treatment and weave fabrics. The number
represents the number of directions of slide, wherein 4L is
indicative of low friction in all directions, and the letter
represents the friction, with L being low friction, ML being
medium low friction, M being medium friction, MH being medium
high friction, and H being high friction.

| | 1^{st} vector | 1^{st} vector | 2^{nd} vector | 2^{nd} vector |
|---|---|---|---|---|
| Relative to | Orthogonal | Parallel | Parallel | Orthogonal |
| long/asperities | | | | |
| vector | | | | |
| Satin | 4L | 2L-2H | 2L*-2H | 4L |
| 100% polyester | 4L | 2L-2H | 2L*-2H | 4L |
| taffeta with | | | | |
| carbon fiber | | | | |
| thread | | | | |
| 100% polyester | 4L | 4L | 4L | 4L |
| taffeta | | | | |
| 100% polyester | 2L-2H | 2L-2H | 2L*-2H | 2L*-2H |
| microfiber | | | | |
| coated with | | | | |
| DWR | | | | |
| 100% polyester | 2L-2H | 2L-2H | 2L*-2H | 2L*-2H |
| microfiber | | | | |

*lateral direction has the lower friction

### Example 14

The knit used was 82% polyester, 18% elastane jersey knit with wicking and antibacterial treatment. Both satin and the 100% polyester with carbon fibre thread provided four directions of movement when either the first or second vectors were orthogonal to the long vector or asperities vector, respectively. The satin also provided for either lateral or longitudinal slide with high friction in the other direction when the vectors were in the parallel orientation. This provides the potential to allow two directional movement or slide (for example, either lateral or longitudinal but not both), while inhibiting four directional slide. Hence, for example, if a user is in an inclined bed, the orientation of the fabrics would be such that lateral movement was made easy, while longitudinal movement was inhibited, hence reducing or ameliorating the problem of the user sliding out of position, and ending up slumped at the foot of the bed. Again, the taffeta provided low friction in all directions independent of orientation.

TABLE 10
82% polyester, 18% elastane jersey knit with wicking and antibacterial
treatment and weave fabrics. The number represents the number of
directions of slide, wherein 4L is indicative of low friction in all
directions, and the letter represents the friction, with L being low
friction, ML being medium low friction, M being medium friction,
MH being medium high friction, and H being high friction.

| | 1^{st} vector | 1^{st} vector | 2^{nd} vector | 2^{nd} vector |
|---|---|---|---|---|
| Relative to | Orthogonal | Parallel | Parallel | Orthogonal |
| long/asperities | | | | |
| vector | | | | |
| Satin | 4L | 2L-2H | 2L*-2H | 4L |
| 100% polyester | 4L | 2L-2MH | 2L*-2ML | 4L |
| taffeta with | | | | |
| carbon fiber | | | | |
| thread | | | | |
| 100% polyester | 4L | 4L | 4L | 4L |
| taffeta | | | | |
| 100% polyester | 3L-1H** | 2L-2H | 2L*-2ML | 2L*-2ML |
| microfiber | | | | |
| coated with | | | | |
| DWR | | | | |
| 100% polyester | 2L-2H | 3L-1H** | 2L*-2M | 2L*-2H |
| microfiber | | | | |

*low friction in the lateral direction.
**low friction one direction laterally, and high the other direction laterally, with high friction longitudinally. Functionally, this is the ideal for an adjustable bed in that there could be low friction for side to side movement one direction across the bed, with higher friction down the bed deterring unwanted slide to bottom of bed.

### Example 15

The knit fabric was 92% polyester, 8% elastane (jersey knit) with wicking and antibacterial treatment. Both satin and the 100% polyester with carbon fibre thread provided four directions of movement when the first vector was orthogonal to the long vector or asperities vector, respectively. With the exception of the taffeta, all provided for either lateral or longitudinal slide with high friction in the other direction when the vectors were in the parallel orientation (the 100% polyester microfiber provided for medium friction in one direction when the second vector was in the parallel orientation, rather than low friction). This provides the potential to allow two directional movement or slide (for example, either lateral or longitudinal but not both), while inhibiting four directional slide. It is expected that this knit provides superior two directional slide and could potentially be used with a wide range of weave fabrics to achieve low friction laterally and high friction longitudinally, or the converse, but less important outcome. Hence, for example, if a user is in an inclined bed, the orientation of the fabrics would be such that lateral movement was made easy, while longitudinal movement was inhibited, hence reducing or ameliorating the problem of the user sliding out of position, and ending up slumped at the foot of the bed. Again, the taffeta provided low friction in all directions independent of orientation.

TABLE 11
92% polyester, 8% elastane (jersey knit) with wicking and antibacterial
treatment and weave fabrics. The number represents the number of
directions of slide, wherein 4L is indicative of low friction in
all directions, and the letter represents the friction, with L being
low friction, ML being medium low friction, M being medium friction,
MH being medium high friction, and H being high friction.

| | 1^{st} vector | 1^{st} vector | 2^{nd} vector | 2^{nd} vector |
|---|---|---|---|---|
| Relative to | Orthogonal | Parallel | Parallel | Orthogonal |
| long/asperities | | | | |
| vector | | | | |
| Satin | 4L | 2L-2H | 2L*-2H | 4L |
| 100% polyester | 4L | 2L-2H | 2L*-2H | 4L |
| taffeta with | | | | |
| carbon fiber | | | | |
| thread | | | | |
| 100% polyester | 4L | 4L | 4L | 4L |
| taffeta | | | | |
| 100% polyester | 2L-2MH | 2L-2H | 2L*-2H | 2L*-2MH |
| microfiber | | | | |
| coated with | | | | |
| DWR | | | | |
| 100% polyester | 2L-2H | 2L-2H | 2M*-2H | 2M*-2H |
| microfiber | | | | |

*denotes lower friction laterally

### Example 16

The knit was 100% polyester wicking pique. Both satin and the 100% polyester with carbon fibre thread provided four directions of movement when the first vector was orthogonal to the long vector or asperities vector, respectively. They also provided for longitudinal slide with low friction and high friction laterally when the vectors were in the parallel orientation. The 100% polyester microfiber also provided for longitudinal slide with high friction in the other direction when the vectors were in the parallel orientation. Again, the taffeta provided low friction in all directions independent of orientation.

TABLE 12
100% polyester wicking pique knit and weave fabrics. The number
represents the number of directions of slide, wherein 4L is
indicative of low friction in all directions, and the letter
represents the friction, with L being low friction, ML being
medium low friction, M being medium friction, MH being medium
high friction, and H being high friction.

| | 1^{st} vector | 1^{st} vector | 2^{nd} vector | 2^{nd} vector |
|---|---|---|---|---|
| Relative to | Orthogonal | Parallel | Orthogonal | Parallel |
| long/asperities | | | | |
| vector | | | | |
| Satin | 4L | 2L-2H | 4L | 2L-2H |
| 100% polyester | 4L | 2L-2H | 4L | 2L-2H |
| taffeta with | | | | |
| carbon fiber | | | | |
| thread | | | | |
| 100% polyester | 4L | 4L | 4L | 4L |
| taffeta | | | | |
| 100% polyester | 2L-2H | 2L-2H | 2L-2H | 2L-2H |
| microfiber | | | | |
| coated with | | | | |
| DWR | | | | |
| 100% polyester | 2M-2H | 2ML-2H | 2M-2H | 2L-2H |
| microfiber | | | | |

### Example 17

A summary of the results for the various knit fabrics demonstrates that generally speaking, surface treated fabrics do not provide good results for either low friction in all directions or low friction in one of the lateral and longitudinal directions. Those fabrics containing polyester-elastane mixes appear to be superior in both these regards. Notably, these are all jersey knits. The pique knit also performed well. However, specific combinations using the other fabrics can be seen to provide the required features of one or the other or both of low friction in all directions and low friction in two directions and high in the other two. In general, the low friction-high friction directionality occurs when one or more of the first and second vectors are parallel to one of the long vector or asperities vector.

TABLE 13
Summary of results for the knit fabrics.

| | | | Low friction in | |
|---|---|---|---|---|
| | | | two directions | |
| | | Low friction in | and high in | |
| Table | Knit Fabric | all directions | other two | Total |
| 1 | 87%/13% | 6 | 8 | 14 |
| | polyester/elastane | | | |
| | jersey knit | | | |
| 2 | 100% nylon tricot | 6 | 6 | 12 |
| | knit | | | |
| 3 | 100% polyester | 6 | 4 | 10 |
| | micromesh | | | |
| 4 | 82%/18% | 6 | 10 | 16 |
| | polyester/elastane | | | |
| | jersey knit | | | |
| 5 | 85%/15% | 8 | 6 | 14 |
| | nylon/elastane | | | |
| | jersey knit | | | |
| 6 | Surface-treated | 8 | 4 | 12 |
| | 100% polyester | | | |
| | interlock | | | |
| 7 | Surface-treated | 8 | 6 | 11 |
| | 100% recycled | | | |
| | polyester interlock | | | |
| 8 | 100% polyester | 8 | 2 | 10 |
| | mesh | | | |
| 9 | Surface-treated | 8 | 12 | 20 |
| | 47% nylon, 47% | | | |
| | polyester, 6% | | | |
| | elastane | | | |
| 10 | Surface-treated | 8 | 5 | 13 |
| | 82%/18% | | | |
| | polyester/elastane | | | |
| 11 | 92% polyester, 8% | 8 | 8 | 16 |
| | elastane jersey | | | |
| | knit | | | |
| 12 | 100% polyester | 8 | 9 | 17 |
| | wicking pique | | | |

### Example 18

A summary of the results for the weave fabrics shows that the satin and 100% polyester with carbon fibre thread provided the greatest number of combinations that led to low friction in all directions and low friction in two directions with high friction in the other two directions. Overall, all fabrics were able to be combined with the knits to provide a reasonable number of combinations leading to low friction in two directions and high friction in the other two directions. In general, the low friction-high friction directionality occurs when one or more of the first and second vectors are parallel to one of the long vector or asperities vector.

Notably, the 100% polyester microfiber treated with DWR provided low friction in two directions and high friction in the other two directions regardless of the orientation, when paired with either the 87% polyester/13% elastane knit or the 100% polyester wicking pique knit. This fabric was superior in providing the low friction-high friction directionality. The 100% polyester taffeta provided low friction in all directions, and failed to provide any differences in friction in the different directions. This suggests that the carbon fibre thread in the taffeta with carbon fibre thread is important in imparting directionality to the fabric.

TABLE 14
Summary of the results for the weave fabrics

| | | Low friction in two | |
|---|---|---|---|
| | Low friction in all | directions and high | |
| | directions | in other two | Total |
| Satin | 24 | 18 | 42 |
| 100% polyester | 24 | 14 | 38 |
| taffeta with | | | |
| carbon fiber | | | |
| thread | | | |
| 100% polyester | 40 | 0 | 40 |
| taffeta | | | |
| 100% polyester | 4 | 30 | 34 |
| microfiber | | | |
| coated | | | |
| with DWR | | | |
| 100% polyester | 1 | 17 | 18 |
| microfiber | | | |

### Example 19

While the combination of knit with weave fabrics is preferred, in some situations, weave on weave may be preferred. Hence, these combinations were studied. We found that some combinations of weaves provided low friction in all directions when the long or asperities vectors were orthogonal. While this would not be unexpected for a satin weave on satin weave, as it has been previously reported in the prior art, it was unexpected to find for satin and the unbalanced plain weaves and the unbalanced plain weaves on unbalanced plain weaves. Significantly, some weave on weave combinations produced directionally specific friction, with low friction in two directions and high friction in the other two directions. This tended to occur when the vectors were parallel.

TABLE 15
Satin on weave. The number represents the number of directions
of slide, wherein 4L is indicative of low friction in all
directions, and the letter represents the friction, with
L being low friction, ML being medium low friction, M being
medium friction and H being high friction.

| Relative to long/asperities vector | Orthogonal | Parallel |
|---|---|---|
| Satin | 4L | 2M-2H |
| 100% polyester taffeta | 4L | 2L-2H |
| with carbon fiber thread | | |
| 100% polyester microfiber coated | 4L | 2L-2H |
| with DWR | | |
| 100% polyester microfiber | 2L-2H | 2L-2MH |

TABLE 16
100% polyester with carbon fibre thread on weave. The
number represents the number of directions of slide,
wherein 4L is indicative of low friction in all directions,
and the letter represents the friction, with L being
low friction, ML being medium low friction, M being
medium friction and H being high friction.

| Relative to long/asperities vector | Orthogonal | Parallel |
|---|---|---|
| Satin | 4L | 2L-2M |
| 100% polyester with carbon fiber | 4L | 2L-2H |
| thread | | |
| 100% polyester microfiber coated | 4L | 2L-2ML |
| with DWR | | |
| 100% polyester microfiber | 2L-2M | 4L |

TABLE 17
100% polyester microfiber coated with DWR on weave. The number
represents the number of directions of slide, wherein 4L is indicative
of low friction in all directions, and the letter represents the
friction, with L being low friction, ML being medium low friction,
M being medium friction and H being high friction.

| Relative to long/asperities vector | Orthogonal | Parallel |
|---|---|---|
| Satin | 4L | 2L-2H |
| 100% polyester with carbon fiber | 4L | 2L-2ML |
| thread | | |
| 100% polyester microfiber coated | 4L | 2L-2MH |
| with DWR | | |
| 100% polyester microfiber | 2L-2MH | 4L |

TABLE 18
100% polyester microfiber on weave. The number represents the
number of directions of slide, wherein 4L is indicative of low
friction in all directions, and the letter represents the friction,
with L being low friction, ML being medium low friction, M being
medium friction and H being high friction.

| Relative to long/asperities vector | Orthogonal | Parallel |
|---|---|---|
| Satin | 2H-2L | 2L-2M |
| 100% polyester with carbon fiber | 2L-2M | 4L |
| thread | | |
| 100% polyester microfiber coated | 2L-2MH | 4L |
| with DWR | | |
| 100% polyester microfiber | 4M | 2M-2H |

### Example 20

While the combination of knit with weave fabrics is preferred, in some situations, knit on knit may be preferred. Hence, these combinations were studied. We found that some combinations of knits provided low friction in all directions when the asperities vectors were orthogonal. As this has only been reported for tricot when the “shiny sides” were together and the machine directions were orthogonal, this was an unexpected finding. Most notably, 85%/15% nylon/elastane, jersey knit provided for low friction in all directions with almost all the other knit fabrics. Significantly, some knit on knit combinations produced directionally specific friction, with low friction in two directions and high friction in the other two directions. This tended to occur when the vectors were parallel. Again, 85%/15% nylon/elastane, jersey weft knit was very effective in this regard. Despite the teaching of the prior art, very few combinations demonstrated high friction in all directions when the vectors were parallel to one another.

TABLE 19
Knit on knit. The number represents the number of directions
of slide, wherein 4L is indicative of low friction in all
directions, and the letter represents the friction, with
L being low friction, ML being medium low friction, M being
medium friction and H being high friction.

| | Relative to long/asperities vector | | | |
|---|---|---|---|---|
| | Orthogonal | Parallel | Parallel | Orthogonal |
| 2 on 1 | 4L | 2L-2H | 2M*-2H | 2L*-2M |
| (87%/13% | | | | |
| polyester/ | | | | |
| elastane | | | | |
| jersey knit) | | | | |
| 3 on 1 | 2M*-2MH | 2MH-2H | 4H | 2M-2MH |
| 4 on 1 | 2L*-2ML | 2MH*-2H | 2MH-2H | 2L-2ML |
| 5 on 1 | 4L | 2L*-2H | 2M-2H | 4L |
| 1 on 2 | 2L*-2ML | 2L-2H | 2L-2ML | 2M*-2H |
| (100% nylon | | | | |
| tricot knit) | | | | |
| 3 on 2 | 4L | 2M-2H | 2M-2H | 4L |
| 4 on 2 (weft | 4L | 2M*-2H | 2M-2H | 4L |
| on warp) | | | | |
| 5 on 2 | 4L | 2L*-2H | 2L-2H | 4L |
| 2 on 3 | 4L | 2L-2H | 2M*-2H | 4L |
| (100% | | | | |
| polyester | | | | |
| micromesh) | | | | |
| 5 on 3 | 4L | 2M*-2H | 2M-2H | 4L |
| 2 on 4 | 4L | 2H | 2ML*-2H | 4L |
| (82%/18% | | 1M-1H | | |
| polyester/ | | | | |
| elastane, | | | | |
| jersey knit) | | | | |
| (warp on | | | | |
| weft) | | | | |
| 3 on 4 | 4L | 4H | 4H | 4L |
| 5 on 4 | 2L-2ML | 2ML*-2H | 2L-2H | 4L |
| 2 on 5 | 4L | 2L-2H | 1L*-1H | 2L* |
| (85%/15% | | | 2H | 1L-1H |
| nylon/ | | | | |
| elastane, | | | | |
| jersey knit) | | | | |
| 3 on 5 | 4L | 2MH-2H | 2MH-2H | 4L |
| 2 on 6 | 4L | 2MH-2H | 2MH*-2H | 4ML |
| (Surface- | | | | |
| treated 100% | | | | |
| polyester | | | | |
| interlock) | | | | |
| 3 on 6 | 4L | 4H | 4H | 4L |
| 5 on 6 | 4L | 2MH*-2H | 2MH-2H | 4L |
| 2 on 7 | 4L | 2MH-2H | 4H | 2M*-2H |
| (Surface- | | | | |
| treated 100% | | | | |
| recycled | | | | |
| polyester | | | | |
| interlock) | | | | |
| 3 on 7 | 2ML*-2MH | 4H | 4H | 2ML-2MH |
| 5 on 7 | 4L | 2ML*-2H | 2MH-2H | 4L |
| 2 on 8 | 2L-2H | 2ML-2H | 4H | 2M*-2H |
| (100% | | | | |
| polyester | | | | |
| mesh) | | | | |
| 5 on 8 | 4ML | 2MH*-2H | 2M-2H | 4ML |
| 2 on 9 | 4L | 2M-2H | 2M*-2H | 4L |
| (Surface- | | | | |
| treated 47% | | | | |
| nylon, 47% | | | | |
| polyester, | | | | |
| 6% elastane, | | | | |
| jersey knit) | | | | |
| 3 on 9 | 4L | 4H | 4H | 4L |
| 5 on 9 | 4L | 2MH*-2H | 2MH-2H | 4L |
| 2 on 10 | 4L | 2M-2H | 2M*-2H | 4L |
| (Surface- | | | | |
| treated | | | | |
| 82%/18% | | | | |
| polyester/ | | | | |
| elastane) | | | | |
| 3 on 10 | 4L | 2MH-2H | | 2L* |
| | | | | 1L-1H |
| 5 on 10 | 4L | 2MH-*2H | 2L-2H | 4L |
| 2 on 11 | 4L | 2M-2H | 4H | 2L*-2M |
| (92% | | | | |
| polyester, | | | | |
| 8% elastane, | | | | |
| jersey knit) | | | | |
| 3 on 11 | 2L*-2ML | 4H | 4H | 2L-*-2ML |
| 5 on 11 | 4L | 2MH*-2H | 2M-2H | 4L |
| 2 on 12 | 4L | 2L-2H | 4H | 1L-1H |
| (100% | | | | 2L* |
| polyester | | | | |
| wicking | | | | |
| pique) | | | | |
| 3 on 12 | 4L | 4H | 4H | 4L |
| 5 on 12 | 4ML | 2MH*-2H | 2MH-2H | 4ML |

*denotes lower friction laterally

### Example 21

It is contemplated that a specialty fabric that has different friction zones will be developed and used. Such a fabric would consist of either different weaves or different knits within a single fabric. The foregoing tables provide sufficient information to allow one to predict whether a suitable combination can be used, and if so, what they are to provide a zone or zones of low lateral friction and a zone or zones of high longitudinal friction, a zone or zones of high lateral friction and a zone or zones of low longitudinal friction, a zone or zones of high friction in all directions and a zone or zones of low friction, zones of low friction in all directions and zones of high lateral friction, zones of high friction in all directions and zones of low lateral friction, zones of low friction in all directions and zones of high longitudinal friction and zones of high friction in all directions and zones of low longitudinal friction. The advantage of this approach is that one could combine a seamless surface with a garment having high and low friction areas strategically located on the garment, and made from the same material. Thus the garment would not appear to have different zones, unlike garments that might be made of different fabrics to provide the different levels of friction, and the surface would not have seams, that would be subject to wear nor would it subject a user to potential pressure points.

### Example 22

It is contemplated that a combination can be developed from the data provided herein, or by extrapolating from the data provided herein that will allow for good lateral movement in both directions, and good movement in only one direction longitudinally. This would assist in a user turning in bed, and sliding up in the bed, while reducing slippage down the bed towards the foot of the bed.

### Example 23

An interlock knit, specifically, a polyester interlock knit was examined for long and short vectors. None were found. As this was a suitable material for making comfortable and easy to don and doff clothing, a method of combining garments made with this material with weave material was sought. In studying the fabric, it was found to have an asperities vector. If the asperities vector was aligned to be orthogonal to the long vector (or asperities vector) of the weave fabric, the coefficient of friction was generally low in all directions, but lower when moved in the direction of the long vector (or asperities vector). On the other hand, when the vectors of the two fabrics were parallel, the coefficient of friction was higher. Hence this combination can be used to provide higher friction in one direction and low friction in the other direction. The angle for lower friction is contemplated to be about 45 degrees to about 135. The angle for higher friction is contemplated to be about 0 degrees to about 35 degrees, for this and all combinations demonstrating high and low friction.

### Example 24

Combinations using silk fabrics were studied. A silk jersey knit and a silk plain weave were tested together. The silk plain weave was found to have an asperities vector. The jersey knit has a first and a second vector. When the vectors were aligned to be parallel, there was high friction laterally and low friction longitudinally. When the vectors were orthogonal, there was low friction in every direction.

A silk jersey knit on satin behaves the same as the other jersey knit fabrics on satin.

Silk plain weave on satin was also tested. When the vectors were aligned to be parallel, there was high friction laterally and low friction longitudinally. When the vectors were orthogonal, there was low friction in every direction.

### Example 25

It is contemplated that other natural fibres, if correctly selected and used to make a fabric, could be used in the combinations of the present technology as would be known to one skilled in the art.

The foregoing is an example of the technology. As would be known to one of skill in the art, variations that do not alter the scope of the invention are contemplated.

What is claimed is:

1. A low friction combination comprising a garment and a sheet including a layer of a weave fabric, the garment comprising a machine knit fabric having a surface with a first vector or an asperities vector, the weave fabric comprising a surface having a long vector and a short vector, or an asperities vector, wherein at least a portion of the surface of the machine knit and a portion of the sheet are aligned at a vector angle of about 45 degrees to about 135 degrees to reduce friction between the garment and the sheet and a remainder of the sheet is aligned to increase friction between the garment and the sheet.

2. The combination of claim 1, wherein the weave fabric is a panel in a sheet.

3. The low friction combination of claim 2, wherein the vector angle is about 90 degrees.

4. The combination of claim 2 wherein the garment is selected from the group consisting of a nightgown, hospital gown, underwear, pants, pajamas, shirt, dress, shorts, boxers, a skirt, socks, sports clothing, sleeves, linings, and leggings for under athletic padding and guards, braces and supports.

5. The combination of claim 2, wherein the machine knit fabric is a jersey knit, a pique, a tricot, an interlock knit or a micromesh, each comprising one or more of silk, polyester or nylon.

6. The combination of claim 2 wherein the fabrics each comprise elastane.

7. The combination of claim 6, wherein the weave fabric is a satin weave.

8. The combination of claim 1, wherein the weave fabric is a sheet.

9. The combination of claim 8, wherein the machine knit fabric is a polyester interlock knit.

10. A combination having directionally selective friction, comprising a garment and a layer of a weave fabric, the garment comprising machine knit fabric having a surface with a first vector or an asperities vector, the weave fabric having a long vector and a short vector or an asperities vector, wherein only a portion of the surface of the weave fabric is aligned for contact with the machine knit fabric at a vector angle of about 0 degrees to about 15 degrees to increase friction between the garment and the weave fabric for only one of lateral or longitudinal movement.

11. The combination of claim 10, wherein the first vector or the asperities vector of the machine knit fabric and the long vector or asperities vector of the weave fabric are parallel in the portion of the surface of the weave fabric.

12. The combination of claim 10, wherein the fabrics are aligned to reduce friction for lateral movement.

13. The combination of claim 10, wherein the knit fabric is a 100% polyester micromesh.

14. The combination of claim 10, wherein the surface of the machine knit fabric has the asperities vector.

15. The combination of claim 10, wherein the machine knit fabric is a polyester interlock knit.

16. The combination of claim 10, wherein the weave fabric is a sheet or a panel in a sheet.

17. A combination comprising a first layer that is a machine knit fabric having a surface with a first vector or an asperities vector and a second layer that is a weave fabric having an upper surface having a long vector and a short vector or an asperities vector, wherein the surface of the first layer contacts the upper surface of the second layer, the orientation of the first vector or the asperities vector of the first layer relative to the long vector or asperities vector of the second layer controlling the friction between the first and second layer, such that in use, the layers are oriented such that friction is selectively reduced for only one of lateral or longitudinal movement.

18. The combination of claim 17, wherein the weave fabric is a garment.

19. The combination of claim 18 wherein the garment is selected from the group consisting of a nightgown, hospital gown, underwear, pants, pajamas, shirt, dress, shorts, boxers, a skirt, socks, sports clothing, sleeves and leggings for under athletic padding and guards, braces and supports.

20. The combination of claim 19, wherein there is low friction with lateral movement and high friction with longitudinal movement.

21. The combination of claim 20, wherein the first vector or asperities vector of the first layer is parallel to the long or asperities vector of the second layer in a first section of the combination.

22. The combination of claim 21, wherein the first vector or the asperities vector of the first layer is orthogonal to the long or asperities vector of the second layer in a second section of the combination.

23. (canceled)

24. (canceled)

25. A combination comprising a three over and one under or four over and one under weave fabric and a machine knit fabric, the weave fabric having a long vector, the machine knit fabric having a first vector and a second vector, wherein an orthogonal orientation of the long vector relative to the first and second vector results in low friction associated with movement in all directions, and a parallel orientation of the long vector relative to the first and second vector results in high friction associated with movement in either the lateral or longitudinal direction, but not both.

26. (canceled)

27. (canceled)

28. A combination comprising a three over and one under or four over and one under weave fabric and a machine knit fabric, the weave fabric having a long vector, the machine knit fabric having a first vector and a second vector, wherein a parallel orientation of the long vector relative to the first and second vector results in low friction associated with movement in all directions, and, and an orthogonal orientation of the long vector relative to the first and second vector results in high friction associated with movement in either the lateral or longitudinal direction, but not both.
